(19) United States
(12) Patent Application Publication
(10) Pub. No.: US 2025/0167365 A1
(43) Pub. Date: May 22, 2025

(54) BATTERY CELL INCLUDING INTERNAL STACK EXPANSION CONTROL MECHANISM

(71) Applicant: GM Global Technology Operations LLC, Detroit, MI (US)

(72) Inventors: Nikhil Mone, Rochester Hills, MI (US); Srikant Karunakaran Nambiar, Rochester, MI (US); Umamaheswari Viswanathan, Troy, MI (US); Subrahmanyam Goriparti, Troy, MI (US); Raghavendra Keerthi Manda, Northville, MI (US); Suryanarayana Kolluri, Troy, MI (US)

(21) Appl. No.: 18/514,429

(22) Filed: Nov. 20, 2023

(51) Int. Cl. H01M 50/242; H01M 50/249

(52) U.S. Cl. CPC H01M 50/242; H01M 50/249; H01M 2220/20

(57) ABSTRACT

A battery cell includes a cell can having a base, a plurality of side walls connected to the base, the base and the plurality of side walls defining a cell stack receiving zone. A battery cell stack arranged in the battery stack receiving zone. A resilient expansion limiter is arranged at one of the plurality of side walls in the cell stack receiving zone. The resilient expansion limiter controlling expansion of the battery cell stack.

### INTRODUCTION

The subject disclosure relates to the art of battery assemblies and, more particularly, to a battery cell including an internal stack expansion control mechanism.

Battery assemblies are formed from a plurality of battery cells. Battery cells include stacks of electrodes arranged in a housing. Charging and discharging of the battery cells will, over time, lead to stack expansion. When the stacks expand, pressure is applied to internal housing wall surfaces. In addition, the expansion reduces open spaces in the housing that accommodate an electrolyte. The pressure on the housing and added pressure to the electrolyte resulting from a volume reduction in the housing may detract from battery performance. Accordingly, it is desirable to provide a system for controlling battery stack expansion.

### SUMMARY

A battery cell, in accordance with a non-limiting example, includes a cell can having a base, a plurality of side walls connected to the base, the base and the plurality of side walls defining a cell stack receiving zone. A battery cell stack arranged in the battery stack receiving zone. A resilient expansion limiter is arranged at one of the plurality of side walls in the cell stack receiving zone. The resilient expansion limiter controlling expansion of the battery cell stack.

In addition to one or more of the features described herein the plurality of side walls include a first side wall, a second side wall spaced from the first side wall, a third side wall, and a fourth side wall spaced from the third side wall, the third side wall and the fourth side wall extending between and connecting the first side wall and the second side wall, the resilient expansion limiter being mounted to one of the first side wall and the second side wall.

In addition to one or more of the features described herein the first side wall includes a first area and the third side wall includes a second area, the first area being greater than the second area.

In addition to one or more of the features described herein the resilient expansion limiter includes a first surface mounted to the one of the first side wall and the second side wall and a second surface opposite the first surface.

In addition to one or more of the features described herein the second surface is a substantially planar surface.

In addition to one or more of the features described herein the second surface is a curvilinear surface.

In addition to one or more of the features described herein the resilient expansion limiter includes a plurality of spring elements arranged between the first surface and the second surface.

In addition to one or more of the features described herein the resilient expansion limiter includes a first resilient expansion limiter mounted to the first surface and a second resilient expansion limiter mounted to the second surface.

In addition to one or more of the features described herein a compression pad is arranged between the resilient expansion limiter and the one of the plurality of side walls.

In addition to one or more of the features described herein the resilient expansion limiter includes a honeycomb structure.

A vehicle, in accordance with a non-limiting example, includes a body including a passenger compartment, a plurality of wheels connected to the body, and a drive unit supported in the body. The drive unit is operatively connected to at least one of the plurality of wheels. A battery assembly is supported by the body and electrically connected to the drive unit. The battery assembly includes a plurality of battery cells. Each of the plurality of battery cells includes a cell can having a base, a plurality of side walls connected to the base, the base and the plurality of side walls defining a cell stack receiving zone. A battery cell stack arranged in the battery stack receiving zone. A resilient expansion limiter is arranged at one of the plurality of side walls in the cell stack receiving zone. The resilient expansion limiter controlling expansion of the battery cell stack.

In addition to one or more of the features described herein the plurality of side walls include a first side wall, a second side wall spaced from the first side wall, a third side wall, and a fourth side wall spaced from the third side wall, the third side wall and the fourth side wall extending between and connecting the first side wall and the second side wall, the resilient expansion limiter being mounted to one of the first side wall and the second side wall.

In addition to one or more of the features described herein the first side wall includes a first area and the third side wall includes a second area, the first area being greater than the second area.

In addition to one or more of the features described herein the resilient expansion limiter includes a first surface mounted to the one of the first side wall and the second side wall and a second surface opposite the first surface.

In addition to one or more of the features described herein the second surface is a substantially planar surface.

In addition to one or more of the features described herein the second surface is a curvilinear surface.

In addition to one or more of the features described herein the resilient expansion limiter includes a plurality of spring elements arranged between the first surface and the second surface.

In addition to one or more of the features described herein the resilient expansion limiter includes a first resilient expansion limiter mounted to the first surface and a second resilient expansion limiter mounted to the second surface.

In addition to one or more of the features described herein a compression pad is arranged between the resilient expansion limiter and the one of the plurality of side walls.

In addition to one or more of the features described herein the resilient expansion limiter includes a honeycomb structure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery assembly having battery cells provided with an internal stack expansion control mechanism, in accordance with a non-limiting example;

FIG. 2 is a disassembled view of the battery assembly having battery cells provided with an internal stack expansion control mechanism, in accordance with a non-limiting example;

FIG. 3 is a partial perspective view of battery cells provided with an internal stack expansion control mechanism, in accordance with a non-limiting example;

FIG. 4 is a disassembled perspective view of one of the battery cells of FIG. 3, in accordance with a non-limiting example;

FIG. 5 is a cross-sectional top view of the battery cell taken through the line 5-5 of FIG. 4;

FIG. 6 is a cross-sectional top view of a battery cell provided with an internal stack expansion control mechanism, in accordance with another non-limiting example;

FIG. 7 is a disassembled perspective view of one of the battery cells of FIG. 3, in accordance with another non-limiting example;

FIG. 8 is a cross-sectional top view of the battery cell taken through the line 8-8 of FIG. 7;

FIG. 9 is a cross-sectional top view of a battery cell, in accordance with another non-limiting example;

FIG. 10 is a cross-sectional top view of a battery cell provided with an internal stack expansion control mechanism and a compression pad, in accordance with another non-limiting example;

FIG. 11 is a cross-sectional top view of a battery cell provided with an internal stack expansion control mechanism and a compression pad, in accordance with yet another non-limiting example;

FIG. 12 is a cross-sectional top view of a battery cell provided with an internal stack expansion control mechanism and a compression pad, in accordance with still yet another non-limiting example; and

FIG. 13 is a cross-sectional top view of a battery cell provided with an internal stack expansion control mechanism and a compression pad, in accordance with yet still another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

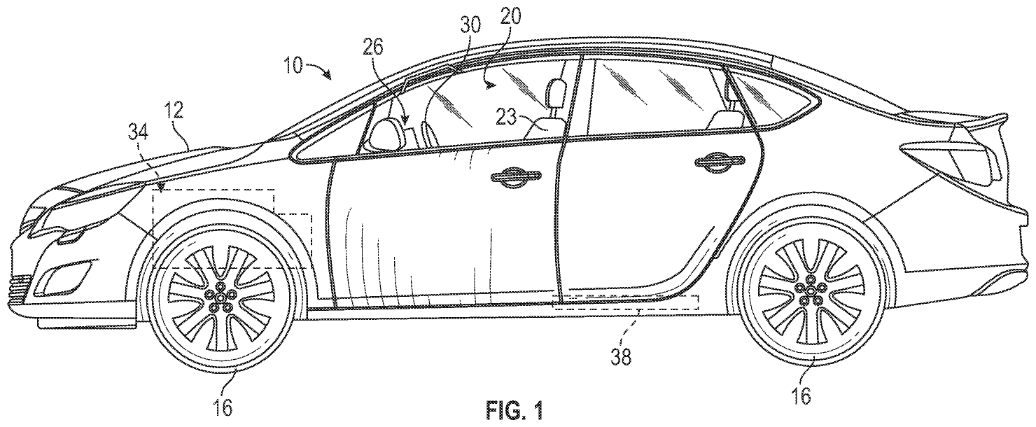

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control orientation of select ones of the plurality of wheels 16. Vehicle 10 includes an electric drive unit 34 that provides power to one or more of the plurality of wheels 16.

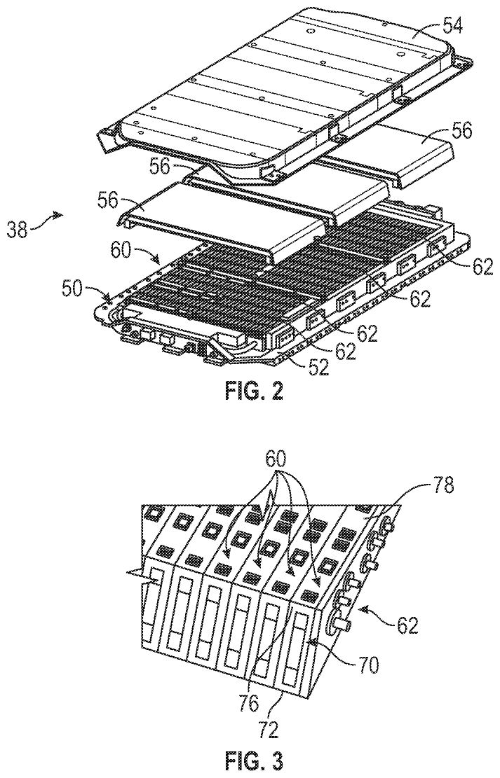

A rechargeable energy storage system (RESS) or battery assembly 38 is arranged in body 12 and provides power to electric drive unit 34. In other arrangements, a fuel cell (not shown) may be used to provide power to electric drive unit 34. At this point, it should be understood that the location of electric drive unit 34 and battery assembly 38 may vary. As shown in FIG. 2, battery assembly 38 includes a housing 50 having a base member 52, an outer cover 54, and a number of inner covers 56. Inner covers 56 shield a plurality of battery cells 60 arranged in a number of adjacent rows 62 as shown in FIG. 3.

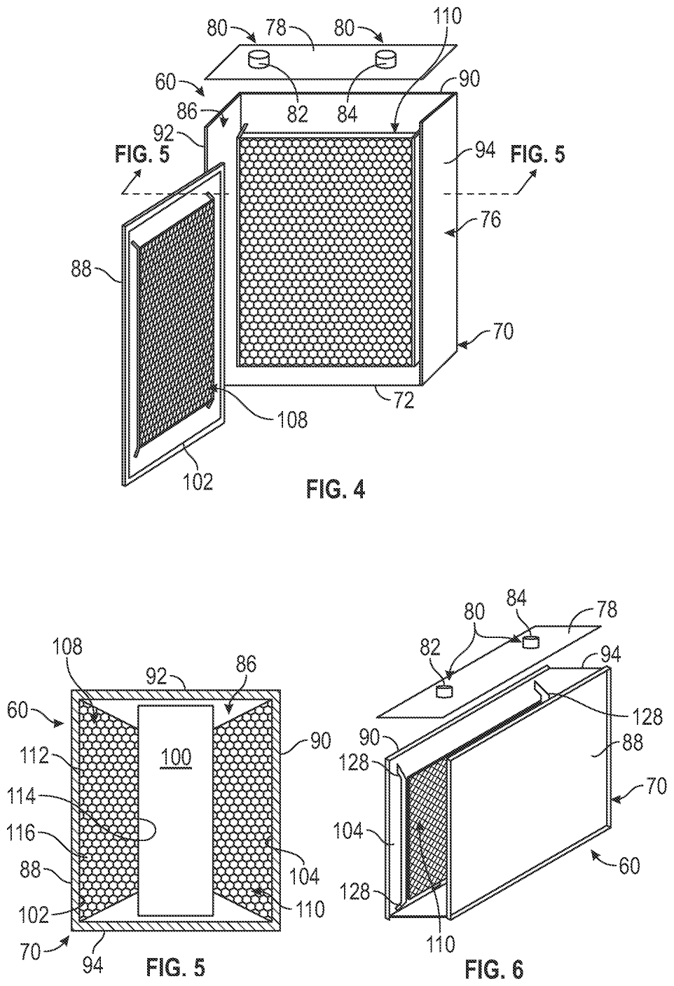

Reference will now follow to FIG. 4 in describing one of the plurality of battery cells 60 with an understanding that remaining ones of the plurality of battery cells 60 may include similar structure. Battery cell 60 includes a cell can 70 having a base 72, a plurality of side walls 76, and a top wall 78. Top wall 78 supports a pair of electrodes 80 including a cathode 82 and an anode 84. Base 72, plurality of side walls 76, and top wall 78 define a cell stack receiving zone 86.

Plurality of side walls 76 include a first side wall 88, a second side wall 90 arranged opposite first side wall 88, a third side wall 92, and a fourth side wall 94 that is arranged opposite third side wall 92. Third side wall 92 and fourth side wall 94 extend between and connect with first side wall 88 and second side wall 90. In one non-limiting example, first side wall 88 and second side wall 90 include a first area and third side wall 92 and fourth side wall 94 include a second area that is smaller than the first area. As shown in FIG. 5, a cell stack 100 is arranged in cell stack receiving zone 86 between first side wall 88 and second side wall 90, and third side wall 92 and fourth side wall 94.

Reference will now follow to FIG. 5 with continued reference to FIG. 4 in describing cell can 70 in accordance with a non-limiting example. First side wall 88 includes a first inner surface 102 and second side wall 90 includes a second inner surface 104 that faces first inner surface 102. Cell can 70 includes a first resilient expansion limiter 108 and a second resilient expansion limiter 110 that confine and limit outward expansion of cell stack 100. Reference will continue follow to FIG. 5 in describing first resilient expansion limiter 108 with an understanding that second resilient expansion limiter 110 includes corresponding structure. Further, while shown with two expansion limiters, cell can 70 may also be provided with a single expansion limiter or more than two expansion limiters depending on design requirements.

In a non-limiting example, first resilient expansion limiter 108 includes a first surface 112 and an opposing second surface 114 between which is defined a resilient expansion media 116. First surface 112 is secured to first inner surface 102 of first side wall 88. First surface 112 may be secured using a wide variety of techniques including adhesive, welding, soldering, over molding and the like, depending on the material used to form resilient expansion media 116. In a non-limiting example, first surface 112 may define a first side (not separately labeled) of resilient expansion media 116 and second surface 114 may define a second side (also not separately labeled) of resilient expansion media 116.

In a non-limiting example, first resilient expansion media 116 is a honeycomb member formed from a resilient material such as metal, including aluminum, steel, and various alloys and composites including polymer composites that are non-reactive to electrolyte and yet exhibit resiliency to absorb cell stack expansions. First resilient expansion limiter 108 and second resilient expansion limiter 110 instead of being formed from a resilient material may include spring elements such as shown at 128 in FIG. 6 disposed between first surface 112 and second surface 114. Regardless of the material being employed, first resilient expansion limiter 108 and second resilient expansion limiter 110 are designed to expand and contract with cell stack 100 without increasing pressure on first side wall 88 and second side wall 90 in such a manner that would lead to an outer dimensional change to cell can 70.

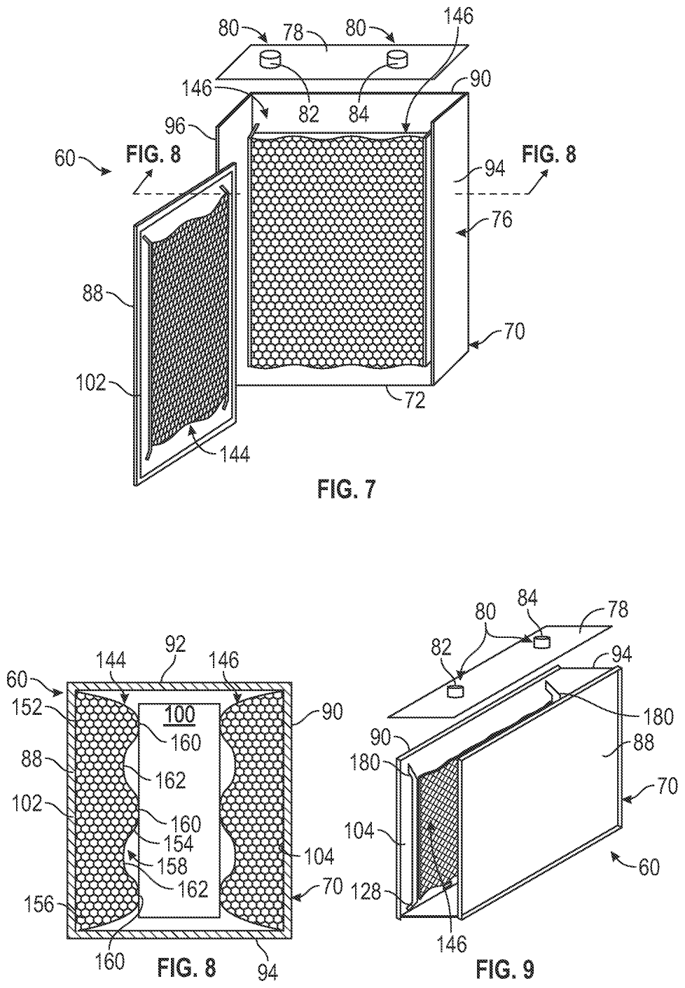

Reference will now follow to FIGS. 7, 8, and 9, in describing a first resilient expansion limiter 144 and a second resilient expansion limiter 146 in accordance with another non-limiting example. As first resilient expansion limiter 144 and second resilient expansion limiter 146 are substantially similarly formed, a detailed description will follow referencing first resilient expansion limiter 144. In a non-limiting example, first resilient expansion limiter 144 includes a first surface 152 and a second surface 154 between which is defined a resilient expansion media 156. First surface 152 is substantially planer and may be secured to first inner surface 102 using a wide variety of techniques including adhesive, welding, soldering, over molding and the like, depending on the material used to form resilient expansion media 156.

In a non-limiting example, second surface 154 is an undulating or curvilinear surface 158 including peaks 160 and troughs 162. Undulating or curvilinear surface 158 may define a corrugated surface 158. In a manner also similar to that discussed herein, first surface 152 may define a first side (not separately labeled) of resilient expansion media 156 and second surface 154 may define a second side (also not separately labeled) of resilient expansion media 156.

In a non-limiting example, resilient expansion media 156 is a honeycomb member formed from a resilient material such as metal, including aluminum, steel, and various alloys and composites including polymer composites that are non-reactive to electrolyte and yet exhibit resiliency to absorb cell stack expansions. First resilient expansion limiter 144 and second resilient expansion limiter 146 instead of being formed from a resilient material; may include spring elements such as shown at 180 in FIG. 9. Regardless of the material being employed, first resilient expansion limiter 144 and second resilient expansion limiter 146 are designed to expand and contract with cell stack 100 without increasing pressure on first side wall 88 and second side wall 90 in such a manner that would lead to an outer dimensional change to cell can 70.

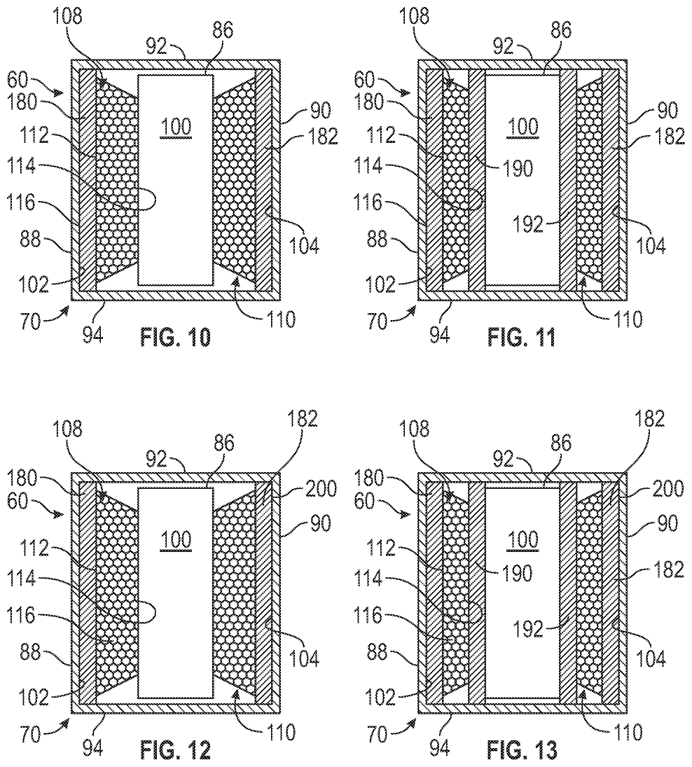

Reference will now follow to FIGS. 10, 11, 12, and 13 in describing a battery cell 60 in accordance with additional non-limiting examples. Referring to FIG. 10, in addition to first resilient expansion limiter 108 and second resilient expansion limiter 110 battery cells 60 includes a first compression pad 180 and a second compression pad 182. First compression pad 180 is arranged between first resilient expansion limiter 108 and inner surface 102 of first wall 88 and second compression pad 182 is arranged between second resilient expansion limiter 110 and second inner surface 104 of second side wall 90. First compression pad 180 and second compression pad 188 provide additional expansion absorption properties for cell stack 100.

Referring to FIG. 11, in addition to first compression pad 180 and second compression pad 182, battery cell 60 includes a third compression pad 190 and a fourth compression pad 192. Third compression pad 190 is arranged between first resilient expansion limiter 108 and cell stack 100 and fourth compression pad 192 is arranged between cell stack 100 and second resilient expansion limiter 110. In a non-limiting example, first compression pad 180, second compression pad 182, third compression pad 190, and/or fourth compression pad 192 may be formed from a variety of materials that can withstand contact with an electrolyte. In one non-limiting example, the material may be a purpose material that not only accommodates dimensional changes in cell stack 100 but also accommodate volumetric changes of the electrolyte.

In addition to accommodating volumetric changes, one or more of first compression pad 180, second compression pad 182, third compression pad 190, and/or fourth compression pad 192 may include a thermally resistant coating that reduces temperatures at outer surfaces of cell can 70. For example, second compression pad 182 may include a thermal barrier coating 200 as shown in FIG. 12 and in FIG. 13. Further, while shown as a supplement to the resilient expansion limiters, the compression pads may be used on their own.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell comprising:
a cell can including a base, a plurality of side walls connected to the base, the base and the plurality of side walls defining a cell stack receiving zone;
a battery cell stack arranged in the cell stack receiving zone; and
a resilient expansion limiter arranged at one of the plurality of side walls in the cell stack receiving zone, the resilient expansion limiter controlling expansion of the battery cell stack.

2. The battery cell according to claim 1, wherein the plurality of side walls include a first side wall, a second side wall spaced from the first side wall, a third side wall, and a fourth side wall spaced from the third side wall, the third side wall and the fourth side wall extending between and connecting the first side wall and the second side wall, the resilient expansion limiter being mounted to one of the first side wall and the second side wall.

3. The battery cell according to claim 2, wherein the first side wall includes a first area, and the third side wall includes a second area, the first area being greater than the second area.

4. The battery cell according to claim 2, wherein the resilient expansion limiter includes a first surface mounted to the one of the first side wall and the second side wall and a second surface opposite the first surface.

5. The battery cell according to claim 4, wherein the second surface is a substantially planar surface.

6. The battery cell according to claim 4, wherein the second surface is a curvilinear surface.

7. The battery cell according to claim 4, wherein the resilient expansion limiter includes a plurality of spring elements arranged between the first surface and the second surface.

8. The battery cell according to claim 2, wherein the resilient expansion limiter includes a first resilient expansion limiter mounted to the first side wall and a second resilient expansion limiter mounted to the second side wall.

9. The battery cell according to claim 1, further comprising a compression pad arranged between the resilient expansion limiter and the one of the plurality of side walls.

10. The battery cell according to claim 1, wherein the resilient expansion limiter includes a honeycomb structure.

11. A vehicle comprising:
a body including a passenger compartment;
a plurality of wheels connected to the body;
a drive unit supported in the body, the drive unit being operatively connected to at least one of the plurality of wheels; and
a battery assembly supported by the body and electrically connected to the drive unit, the battery assembly including a plurality of battery cells, each of the plurality of battery cells having:
a cell can including a base, a plurality of side walls connected to the base, the base and the plurality of side walls defining a cell stack receiving zone;
a battery cell stack arranged in the cell stack receiving zone; and
a resilient expansion limiter arranged at one of the plurality of side walls in the cell stack receiving zone, the resilient expansion limiter controlling expansion of the battery cell stack.

12. The vehicle according to claim 11, wherein the plurality of side walls include a first side wall, a second side wall spaced from the first side wall, a third side wall, and a fourth side wall spaced from the third side wall, the third side wall and the fourth side wall extending between and connecting the first side wall and the second side wall, the resilient expansion limiter being mounted to one of the first side wall and the second side wall.

13. The vehicle according to claim 12, wherein the first side wall includes a first area, and the third side wall includes a second area, the first area being greater than the second area.

14. The vehicle according to claim 12, wherein the resilient expansion limiter includes a first surface mounted to the one of the first side wall and the second side wall and a second surface opposite the first surface.

15. The vehicle according to claim 14, wherein the second surface is a substantially planar surface.

16. The vehicle according to claim 14, wherein the second surface is a curvilinear surface.

17. The vehicle according to claim 14, wherein the resilient expansion limiter includes a plurality of spring elements arranged between the first surface and the second surface.

18. The vehicle according to claim 12, wherein the resilient expansion limiter includes a first resilient expansion limiter mounted to the first side wall and a second resilient expansion limiter mounted to the second side wall.

19. The vehicle according to claim 11, further comprising a compression pad arranged between the resilient expansion limiter and the one of the plurality of side walls.

20. The vehicle according to claim 11, wherein the resilient expansion limiter includes a honeycomb structure.
